(19) United States
(12) Patent Application Publication
(10) Pub. No.: US 2008/0205825 A1
(43) Pub. Date: Aug. 28, 2008

(54) Power limiting optical device

(75) Inventor: Barbara Grzegorzewska, Riverside, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/637,335

(22) Filed: Dec. 12, 2006

Related U.S. Application Data
(60) Provisional application No. 60/818,141, filed on Jun. 30, 2006.

(51) Int. Cl. G02B 6/38; G02B 6/00

(52) U.S. Cl. 385/60; 385/140

(57) ABSTRACT

An optical device includes a housing having a front connector interface and a rear connector interface. The housing houses optics that provide an optical pathway from the front connector interface to the rear connector interface. The front connector interface is configured to be coupled with a first optical connector such that an optical signal from the first optical connector travels along the optical pathway. The rear connector interface is configured to be coupled with a second optical connector such that the second optical connector receives the optical signal from the optical pathway. The optical device includes an attenuator in the housing. The attenuator is configured to scatter the optical signal traveling along the optical pathway such that power of the optical signal is attenuated.

### RELATED APPLICATIONS

This application claims the benefit of U.S. Provisional Application No. 60/818,141, filed on Jun. 30, 2006, entitled “POWER LIMITING OPTICAL DEVICE,” and incorporated by reference herein in its entirety.

### TECHNICAL FIELD

The present invention relates to optical connectors, and more particularly to optical interconnects that include optical attenuators.

### BACKGROUND

The success of optical communications networks can depend on the ability to control the power of optical signals. For instance, the power of optical signals often must be limited to prevent damage to the network. As a result, optical attenuators and optical limiters can play a crucial role in an optical network. Of particular interest are dynamic attenuators that output an optical signal with a substantially constant power despite receiving an input signal with a varying power. However, interfacing these attenuators with current optical network technology is often complex. As a result, there is a need for simplification of the interface between existing optical network technology and the optics for controlling power of optical signals.

### SUMMARY

In accordance with an exemplary embodiment of the invention, an optical device includes a housing having a front connector interface and a rear connector interface. The housing houses optics that provide an optical pathway from the front connector interface to the rear connector interface. The front connector interface is configured to be coupled with a first optical connector such that an optical signal from the first optical connector travels along the optical pathway. The rear connector interface is configured to be coupled with a second optical connector such that the second optical connector receives the optical signal from the optical pathway. The optical device includes an attenuator in the housing. The attenuator is configured to scatter the optical signal traveling along the optical pathway such that power of the optical signal is attenuated.

Other aspects, features, embodiments, processes and advantages of the invention will be or will become apparent to one with skill in the art upon examination of the following figures and detailed description. It is intended that all such additional features, embodiments, processes and advantages be included within this description, be within the scope of the invention, and be protected by the accompanying claims.

### BRIEF DESCRIPTION OF THE FIGURES

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1A through FIG. 1D illustrate an attenuating insert that is suitable for use with an optical device. FIG. 1A is a perspective view of the attenuating insert.

FIG. 1B is an exploded view of the attenuating insert shown in FIG. 1A.

FIG. 1C is a cross-section of the attenuating insert shown in FIG. 1A taken along an xy plane where the coordinate system for the xy plane is shown in FIG. 1A.

FIG. 1D is a cross-section of the attenuating insert shown in FIG. 1A taken along an xz plane where the coordinate system for the xy plane is shown in FIG. 1A.

FIG. 2A through FIG. 2E illustrate a device that includes the attenuating insert of FIG. 1A through FIG. 1D. FIG. 2A illustrates an exploded view of the device.

FIG. 2B illustrates an exploded view of the device shown in FIG. 2A with an exploded view of the attenuating insert.

FIG. 2C and FIG. 2D are sideviews of the device shown in FIG. 2A after assembly of the device.

FIG. 2E is a cross-section of the device shown in FIG. 2C taken along a line extending between the brackets labeled E in FIG. 2C.

FIG. 3A through FIG. 3C illustrate an optical system that includes the device coupled with a male optical connector and a female optical adapter. FIG. 3A is a perspective view of the optical system.

FIG. 3B is an exploded view of the optical system shown in FIG. 3A.

FIG. 3C is a cross section of the optical system shown in FIG. 3A taken along the length of the optical system.

FIG. 4A and FIG. 4B illustrate an example of a suitable scattering filter. FIG. 4A is a sideview of the scattering filter.

FIG. 4B is a cross-section of a portion of an attenuating insert that includes a scattering filter.

FIG. 4C illustrates the performance of a scattering filter.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

An optical device includes an optical pathway from a front connector interface to a rear connector interface. The front connector interface is configured to be coupled with a first optical connector and the rear connector interface is configured to be coupled with a second optical connector. As a result, the device is easily interfaced with existing optical networking equipment. Optical signals from the first optical connector can travel along the optical pathway through the device to the second optical connector. The optical device includes an attenuator in the housing. The attenuator is configured to attenuate the optical signal traveling along the optical pathway. Accordingly, the device simplifies the interface between an attenuator and existing optical equipment.

The attenuator in the device can include or consist of a scattering filter having a film with nanoparticles suspended in a substantially transparent support. The film can attenuate optical signals transmitted through the film. The mechanism for this attenuation is described in more detail below. The mechanism permits the scattering filter to operate as a passive dynamic attenuator, a passive optical power limiter and/or as a passive optical fuse. Accordingly, the device simplifies the interface between existing optical networking equipment and a passive dynamic attenuator, a passive optical power limiter and/or a passive optical fuse.

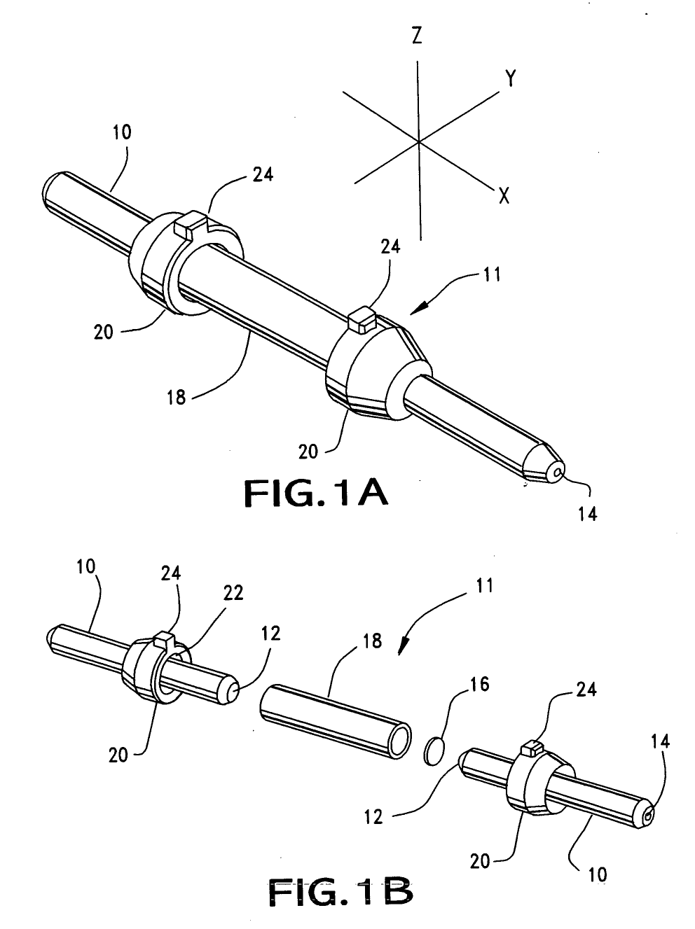

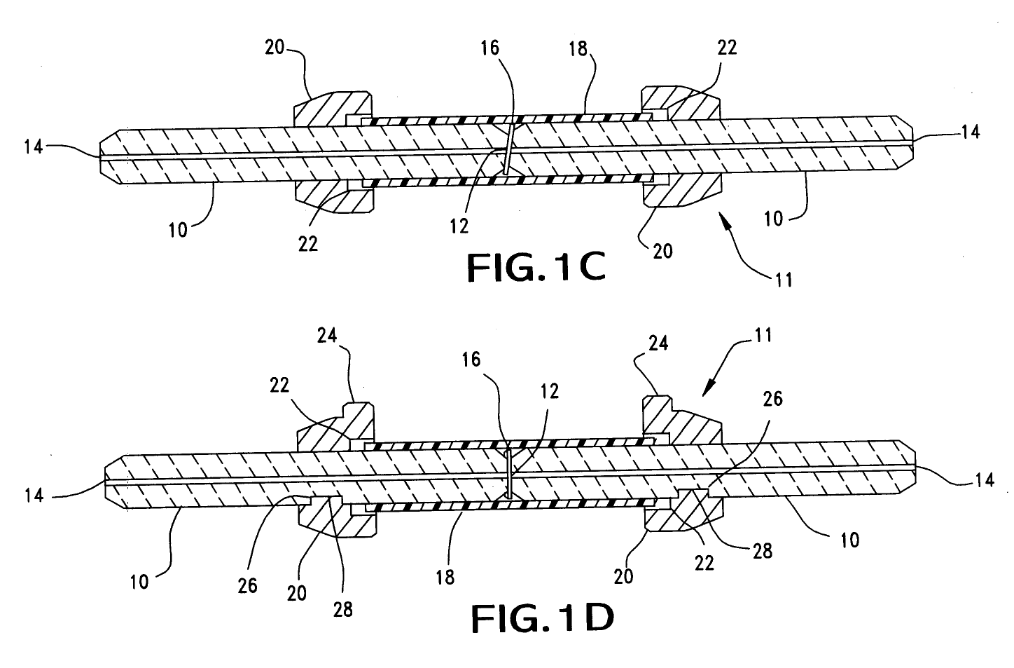

FIG. 1A through FIG. 1D illustrate an attenuating insert 11 that is suitable for use with an optical device. FIG. 1A is a perspective view of the attenuating insert 11. FIG. 1B is an exploded view of the attenuating insert 11 shown in FIG. 1A. FIG. 1C is a cross-section of the attenuating insert 11 shown in FIG. 1A taken along an xy plane. FIG. 1D is a cross-section of the attenuating insert 11 shown in FIG. 1A taken along an xz plane that is perpendicular to the xz plane. The coordinate system for the cross-section planes is shown in FIG. 1A. An example of a suitable scattering filter usable as an attenuator 16 is described below in connection with FIGS. 4A through C.

The attenuating insert 11 includes signal-carrying structures 10 that each has an optical pathway configured to carry an optical signal from an interior port 12 to an exterior port 14. FIG. 1A through FIG. 1D illustrate ferrules serving as the signal-carrying structures 10. The ferrules can include an optical fiber that carries optical signals between the interior port 12 and the exterior port 14. A facet of the optical fiber can serve as the interior port 12 and another facet of the optical fiber can serve as the exterior port 14. Suitable materials for the ferrule include, but are not limited to, ceramics.

The attenuating insert 11 includes an attenuator 16 positioned between the interior ports 12 of the signal-carrying structures 10. In some instance, the interior port 12 of each signal-carrying structure 10 contacts the attenuator 16. In some instances, the attenuator 16 is configured to receive an optical signal from the interior port 12 of one signal-carrying structure 10 and to attenuate a portion of the optical signal and to pass a portion of the optical signal. In some instances, the attenuator 16 is configured to attenuate the optical signal such that the power of the passed portion of the optical signal does not exceed an upper threshold. Accordingly, the portion of the optical signal power that is scattered by the scattering film can vary in response to changes in the input power of the optical signal. The attenuator can be a passive attenuator 16 in that the attenuator 16 does not require energy from sources other than the optical signal in order to provide the required levels of attenuation. An example of a suitable passive attenuator 16 is a scattering device such as a scattering filter. A scattering filter can employ a scattering film configured to transmit at least a portion of an optical signal and can scatter a portion of the optical signal.

The attenuating insert 11 includes an alignment device 18 that aligns the interior ports 12 of the ferrules such that an optical signal exiting an interior port 12 of the one of the signal-carrying structures 10 is received at the attenuator 16 and optical signal passed by the attenuator 16 enters the interior port 12 of the other signal-carrying structure 10. FIG. 1A through FIG. 1D illustrate a sleeve serving as the alignment device 18. The interior ports 12 of the signal-carrying structures 10 are positioned in the sleeve. A suitable sleeve includes, but is not limited to, an alignment sleeve such as an LC standard alignment sleeve.

The attenuating insert 11 includes one or more retainers 20 extending outward from each signal-carrying structure 10. For instance, FIG. 1A through FIG. 1D illustrate a flange serving as a retainer 20 on each of the signal-carrying structures 10. The alignment device 18 is positioned between the retainers 20. The portion of a retainer 20 adjacent to a signal-carrying structure 10 can optionally include a recess or step 22 positioned to receive the alignment device 18. For instance, the retainers 20 illustrated in FIG. 1A through FIG. 1D each includes a step 22 positioned to receive an end of the alignment device 18.

The retainers 20 can also include one or more alignment structures 24 such as projections and/or recesses. For instance, the retainers 20 illustrated in FIG. 1A through FIG. 1D each includes a projection extending outward from the retainer 20. As will become evident below, the alignment structure 24 can be aligned with a complementary structure on a housing for the attenuating insert 11 to achieve the desired orientation of a signal-carrying structure 10 relative to the housing.

The one or more retainers 20 can be integral with the signal-carrying structures 10 or can be non-integral with the signal-carrying structures 10. For instance, FIG. 1A through FIG. 1D illustrate a non-integral retainer 20 being coupled to a signal-carrying structure 10. When the one or more retainers 20 are independent of the signal-carrying structure 10, the one or more retainers 20 can be immobilized relative to signal-carrying structure 10. For instance, FIG. 1D shows the retainers 20 including a bump 26 extending inward toward the signal-carrying structure 10. The bump is complementary to a recess 28 in the signal-carrying structure 10. As is evident from FIG. 1C, the recess in the signal-carrying structure 10 does not surround the signal-carrying structure 10. Accordingly, the bump and the recess effectively immobilize the retainer 20 on the signal-carrying structure 10. Since the retainer 20 is immobilized relative to the signal-carrying structure 10 and one or more alignment structures 24 are located on the retainer 20, the one or more alignment structures 24 are immobilized relative to the signal-carrying structure 10.

When a retainer 20 is independent of a signal-carrying structure 10, the retainer 20 can be overmolded onto the signal-carrying structure 10. Suitable materials for a retainer 20 include, but are not limited to, thermoplastics such as Polyether Imide (PEI).

Although the alignment structures 24 are illustrated as being included on the retainers 20, the alignment structures 24 can be positioned elsewhere on the attenuating insert 11. For instance, the alignment structures 24 can be positioned on a signal-carrying structure 10.

The interior ports 12 can have a non-perpendicular angle relative to the direction of propagation of optical signals through the signal-carrying structures 10 at the interior port 12 as is evident in FIG. 1C. The non-perpendicular angles can reduce back-reflection. Suitable angles for an interior port 12 relative to the direction of propagation of optical signals through the signal-carrying structures 10 at the interior port 12 include, but are not limited to, angles that are less than 90° or less than 88°. In some instances, the angle of the interior port 12 is the same for each of the signal-carrying structures 10. For instance, the interior ports 12 can be angled physical contact (APC) polished with an angle of 82°. The exterior ports 14 of the signal-carrying structures 10 can be angled at ninety degrees of at angles other than ninety degrees. For instance, the exterior ports 14 can be angled physical contact (APC) polished or can be physical contact (PC) polished.

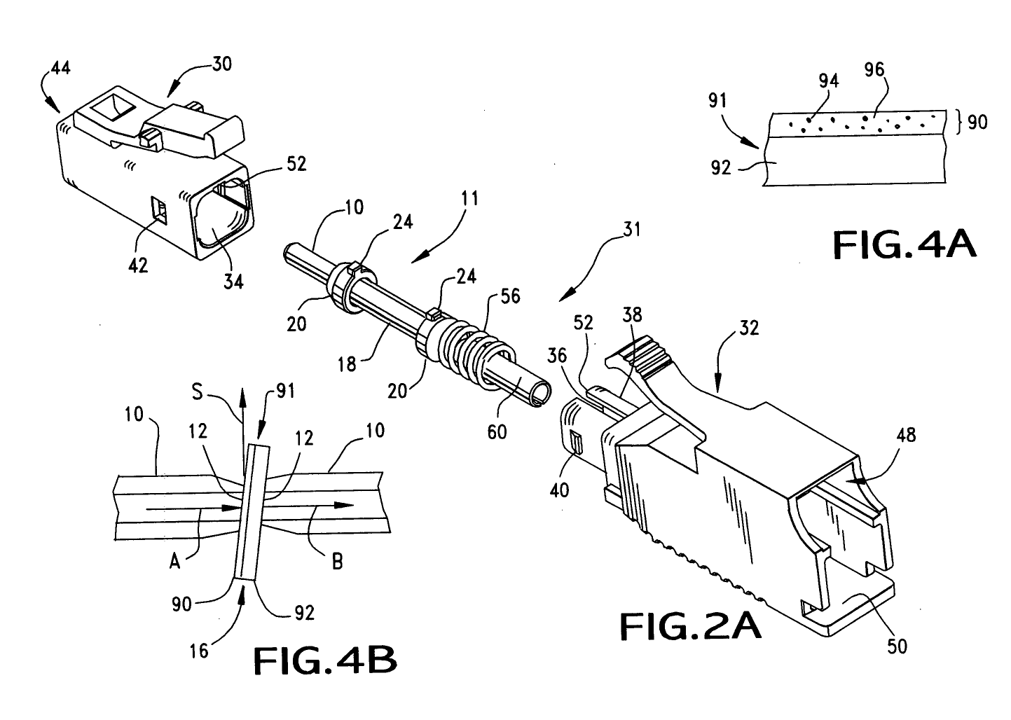

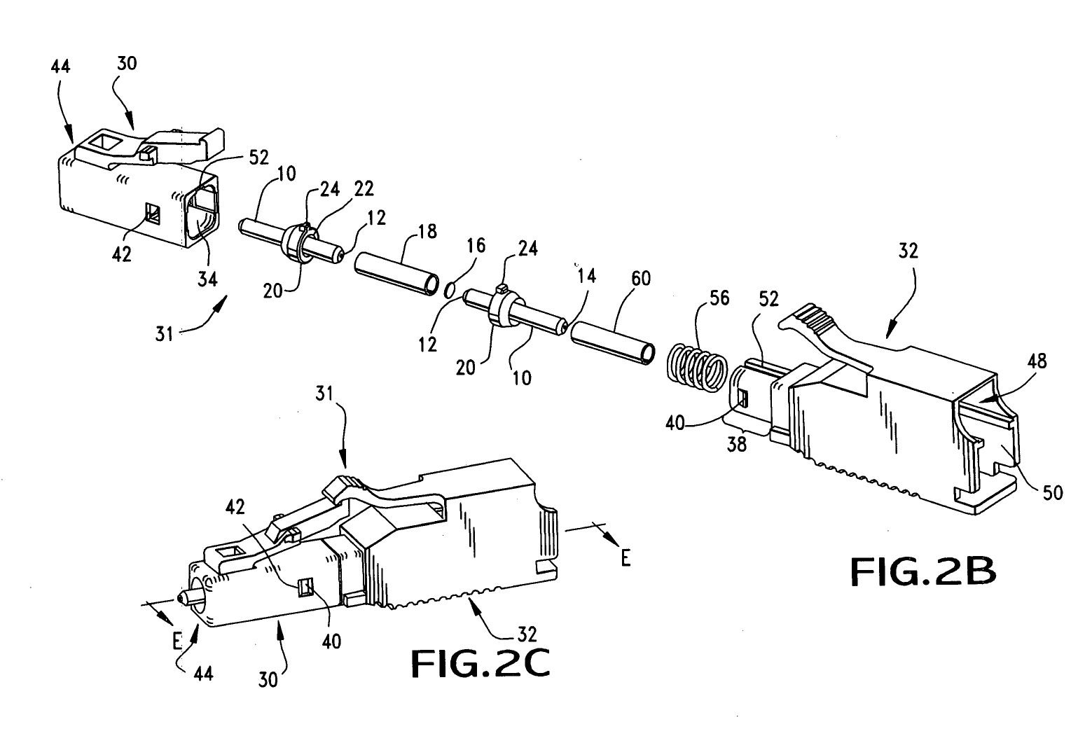

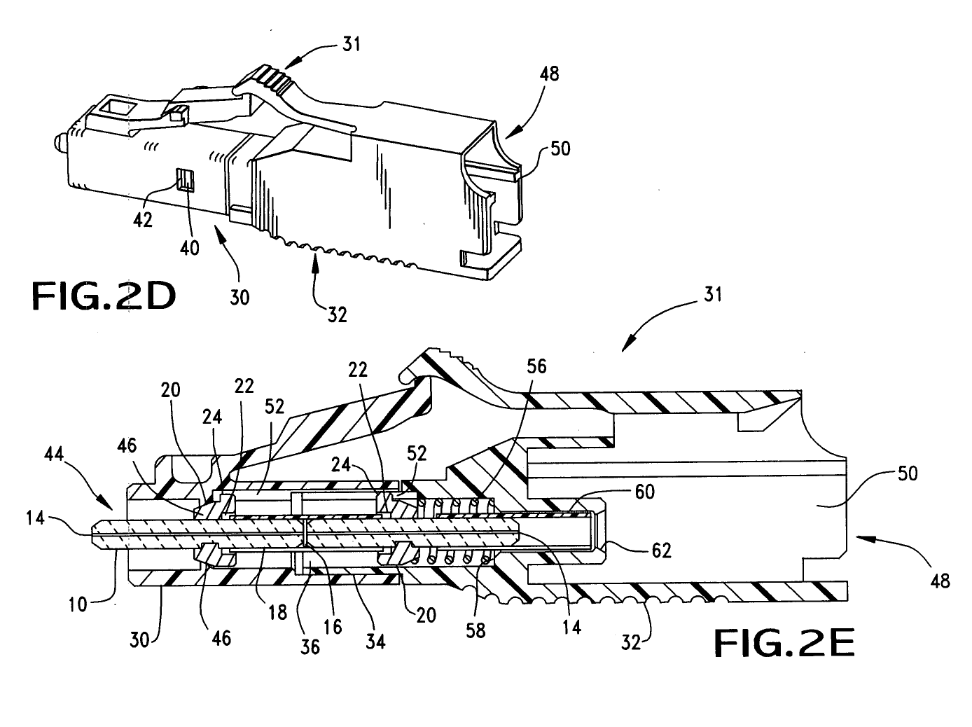

FIG. 2A through FIG. 2E illustrate a device 31 that includes the attenuating insert 11 of FIG. 1A through FIG. 1D. FIG. 2A illustrates an exploded view of the device 31 that includes the attenuating insert 11. FIG. 2B illustrates an exploded view of the device shown in FIG. 2A with an exploded view of the attenuating insert 11. FIG. 2C and FIG. 2D are sideviews of the device 31 shown in FIG. 2A after assembly of the device 31. FIG. 2E is a cross-section of the device 31 shown in FIG. 2C taken along a line extending between the brackets labeled E in FIG. 2C.

The device 31 includes a front body 30 and a rear body 32. The front body 30 can be coupled with the rear body 32 so as to form a housing that houses the attenuating insert 11. The front body 30 and the rear body 32 can be rigid. Accordingly, the housing can be rigid. The front body 30 is configured to receive a portion of the attenuating insert 11. For instance, the front body 30 includes a first opening 34 configured to receive all or a portion one of the signal-carrying structures 10. The rear body 32 is configured to accept a portion of the attenuating insert 11. For instance, the rear body 32 includes a second opening 36 configured to receive all or a portion of the signal-carrying structure 10 that is not received by the front body 30. Accordingly, the attenuating insert 11 can be housed in an interior of the housing when the front body 30 is coupled with the rear body 32. As a result, the housing can act as a box or a case for the attenuating insert 11.

The front body 30 and the rear body 32 can include coupling structures to encourage coupling between the front body 30 and the rear body 32 and/or to resist separation of the front body 30 from the rear body 32. For instance, the front body 30 can include one or more projections configured be received in openings in the rear body 32 and/or the rear body 32 can include one or more projections configured be received in one or more openings in the front body 30. As an example, FIG. 2A through FIG. 2E illustrate the rear body 32 having a projection 38 configured to be received in the first opening 34. As another example, the rear body 32 includes lateral projections 40 that can extend into lateral openings 42 in the side of the front body 30. The lateral projections 40 can be arranged so the lateral projections 40 do not engage the lateral openings 42 until the front body 30 and the rear body 32 have a particular arrangement relative to one another. For instance the lateral projections 40 do not extend into the lateral openings 42 until the rear body 32 is pushed a particular distance into the front body 30. The extension of the lateral projections 40 into the lateral openings resists the separation of the front body 30 and the rear body 32.

The housing includes interfaces that are configured to be coupled with other optical connectors such as optical fiber connectors. Optical fiber connectors include optical fibers for carrying optical signals. Optic connectors are configured to be coupled with one another, with other optical components, and/or with other optical devices such that the optical fibers, optical devices, and/or optical components can exchange optical signals with one another.

The front body 30 includes a front connector interface 44 configured to be coupled with an optical connector. For instance, the first connector includes an insert opening 46 that extends from the first opening 34 through the rear body 32. The attenuating insert II extends through the insert opening 46 such that the exterior port 14 of a signal-carrying structure 10 is accessible from outside of the housing. Accordingly, the front connector interface 44 can serve as a male interface that can be received in the female interface of an optical connector. The front connector interface 44 is preferably configured as a conventional LC-type connector male interface.

The rear body 32 includes a rear connector interface 48 configured to be coupled with an optical connector. For instance, the rear body 32 includes a connector opening 50 configured to receive the male interface of an optical connector (not shown) such as the male interface of a standard LC connector. As is evident in FIG. 2E, the signal-carrying structures define an optical pathway from the front connector interface 44 to the rear connector interface 48.

The front body 30 is configured to receive the attenuating insert 11 such that the attenuating insert 11 has a fixed orientation relative to the front body 30. The particular orientation is rotational orientation rather than longitudinal orientation. Rotational orientation would be varied by rotating the attenuating insert 11 or the signal-carrying structure(s) about a longitudinal axis or about the optical pathway through the attenuating insert 11. The alignment structures on the attenuating insert 11 can be employed to fix the rotational orientation of the attenuating insert 11 relative to the front body 30. For instance, the front body 30 includes an alignment structure 52 that is complementary to an alignment structure 24 on the attenuating insert 11. As an example, the first opening 34 can include a recess that is complementary to one of the projections on the retainer 20. Accordingly, the projection on the retainer 20 fits into the recess in the first opening 34 when the front body 30 is coupled with the rear body 32. As a result, the orientation of the alignment structure 52 on the front body 30 is fixed relative to the alignment structure 24 on the attenuating insert 11. Additionally, as noted above, the one or more alignment structures 24 on the signal-carrying structure 10 can be immobilized relative to the signal-carrying structure 10. As a result, the orientation of a signal carrying structure received by the front body 30 is fixed relative to the front body 30.

The rear body 32 is configured to receive the attenuating insert 11 such that the attenuating insert 11 has a particular orientation relative to the front body 30. For instance, the rear body 32 includes an alignment structure 52 that is complementary to the alignment structure 24 on the attenuating insert 11. As an example, the second opening 36 can include a recess that is complementary to the projection on the retainer 20. Accordingly, the projection on the retainer 20 fits into the recess in the first opening 34 when the front body 30 is coupled with the rear body 32. As a result, the orientation of the alignment structure 52 on the rear body 32 is fixed relative to the alignment structure 24 on the attenuating insert 11. Additionally, as noted above, the one or more alignment structures 24 on the signal-carrying structure 10 can be immobilized relative to the signal-carrying structure 10. As a result, the orientation of the signal carrying structure received by the rear body 32 is fixed relative to the rear body 32.

The alignment structures 52 on the front body 30, the alignment structures 52 on the rear body 32 and the alignment structures 24 on the attenuating insert 11 are arranged such that the interior ports 12 are positioned at a desired angle relative to the attenuator. For instance, the alignment structures can be positioned such that each of the interior ports 12 can be in contact with the attenuator 16. In some instances, the attenuator 16 is a scattering filter and the alignment structures are positioned such that the interior ports 12 are in contact with opposing sides of the scattering filter. Further, the alignment structures can positioned such that the interior ports 12 are each substantially flush against an opposing side of the scattering filter. As a result, each of the interior ports 12 can be a facet of an optical fiber that can be in contact with a side of the scattering filter.

The connector includes an urging mechanism 56 configured to urge the signal-carrying structures 10 toward one another. A spring serves as the urging mechanism 56 in the connector of FIG. 2A through FIG. 2D. The urging mechanism 56 is seated against a second seat 58 in the second opening 36. The urging mechanism 56 extends from the second seat 58 to a retainer 20 on the attenuating insert 11 and pushes against the retainer 20. Accordingly, the urging mechanism 56 pushes the attenuating insert 11 away from the second seat 58. A retainer 20 on the attenuating insert 11 is seated against the insert opening 44. Since the urging mechanism 56 pushes the attenuating insert 11 toward the front body 30 and the attenuating insert 11 is seated in the front body 30, the urging mechanism 56 applies compressive force to the attenuating insert 11. This compression urges the signal-carrying structures 10 toward one another and accordingly encourages the proper positioning of the attenuator 16 between the signal-carrying structures 10. The urging mechanism 56 can also provide a desired mating force at the exposed exterior port 14 extending from the front connector interface 44, such as the mating force typically specified for conventional LC-type connectors.

The device 31 includes a secondary alignment device 60 configured to align the attenuating insert 11 with an alignment opening 62 that extends from the connector opening 50 to the secondary alignment device 60. FIG. 2A through FIG. 2E illustrate a sleeve that serves as the secondary alignment device 60. The secondary alignment device 60 receives the attenuating insert 11 such that the exterior port 14 of a signal-carrying structure 10 is positioned in the secondary alignment device 60. The secondary alignment device 60 is seated against an alignment seat positioned in the second opening 36. A suitable secondary alignment device 60 includes, but is not limited to, an alignment sleeve such as an LC standard alignment sleeve.

Although FIG. 2A through FIG. 2E illustrate the device 31 having a single urging mechanism 56 seated in the rear body 32, the device 31 can include a plurality of urging connectors that urge the signal-carrying structures 10 toward one another. For instance, the device 31 can include a second urging mechanism 56 seated in the front body 30 and extending to a retainer 20.

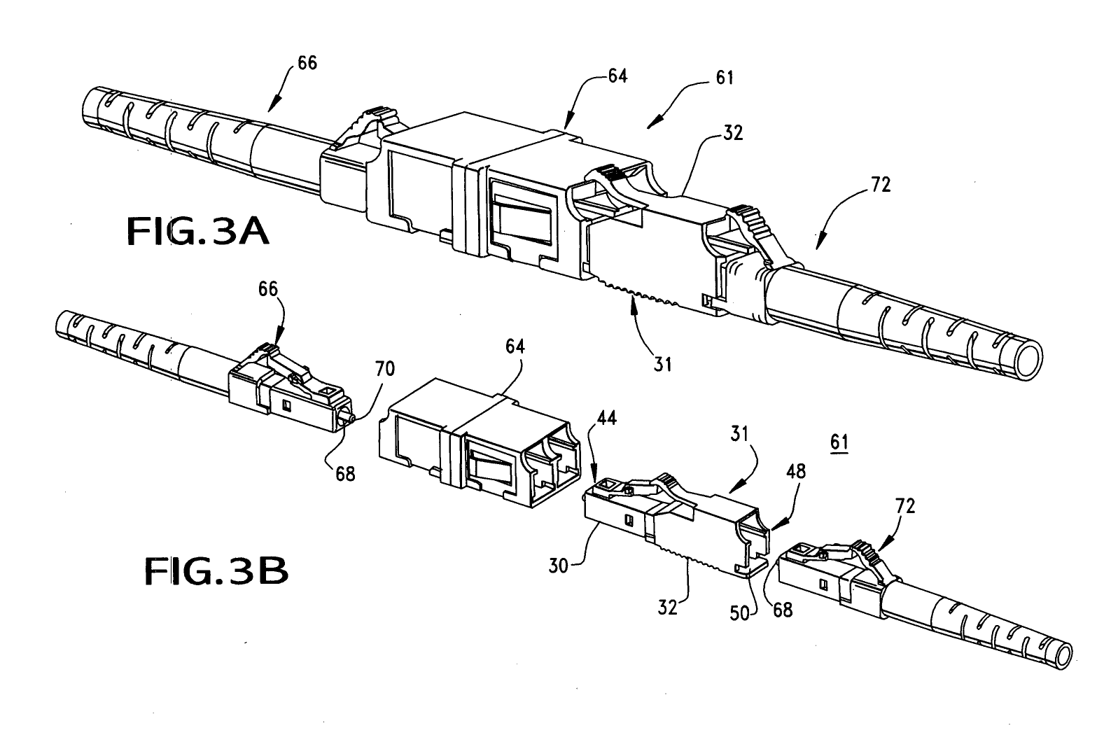

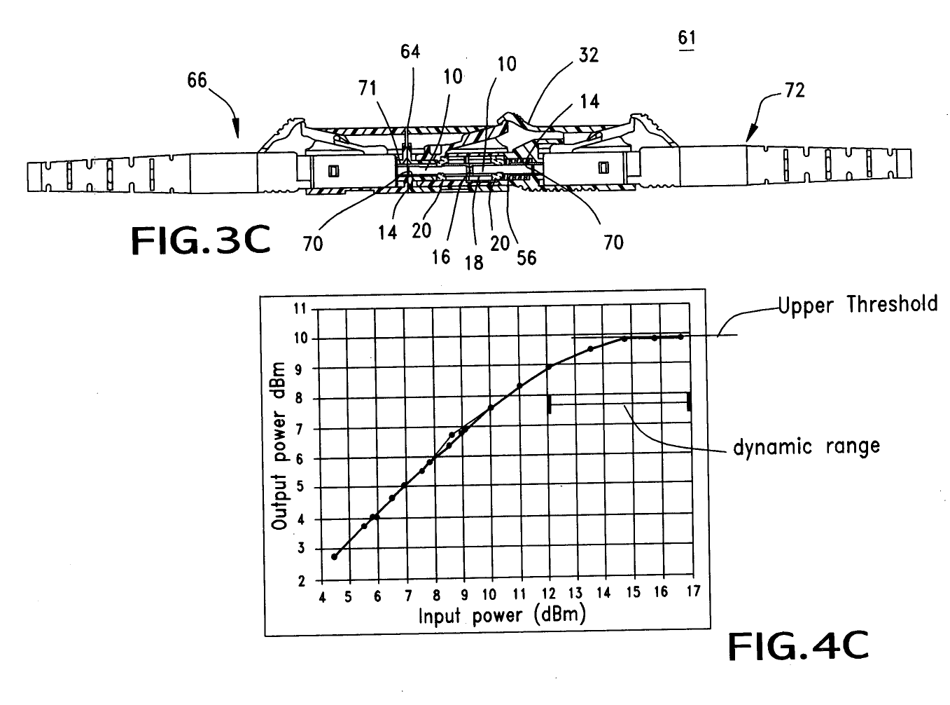

The attenuator connector is configured to be coupled with optical connectors. FIG. 3A through FIG. 3C illustrate an optical system 61 that includes the device 31 coupled with optical connectors. FIG. 3A is a perspective view of the optical system 61. FIG. 3B is an exploded view of the optical system 61 shown in FIG. 3A. FIG. 3C is a cross section of the optical system 61 shown in FIG. 3A taken along the length of the optical system 61.

A dual-port adapter 64 having a total of four female interfaces couples the front connector interface 44 of the device 31 to a first optical fiber connector 66. For instance, the front connector interface 44 of the device 31 is received in a female opening in the adapter 64 and a male interface of the first optical fiber connector 66 is received in another female opening in the adapter 64. An optical fiber connector is typically employed to connect an optical fiber to other optical connectors, other optical devices, and/or to other optical components.

The first optical fiber connector 66 includes a ferrule 68 for terminating an optical fiber. The ferrule 68 includes a port 70 through which optical signals can exit and/or enter the signal-carrying structure 68. For instance, the signal-carrying structure 68 can include an optical fiber and a facet of the optical fiber can serve as the port 70. The port 70 is received in an alignment device 71 that is included in the adapter 64. An exterior port 14 from the attenuating insert 11 is also received in the alignment device 71 such that the exterior port 14 is aligned with the port 70 from the first optical fiber connector 66. The alignment of the port 70 and the exterior port 14 permits exchange of optical signals between the first optical fiber connector 66 and the attenuating insert 11. A suitable alignment device 71 includes, but is not limited to, an alignment sleeve such as an LC standard alignment sleeve.

A second optical fiber connector 72 is coupled with the rear connector interface 48 of the device 31. For instance, the second optical fiber connector 72 includes a male interface received in the connector opening 50 of the device 31. The second optical fiber connector 72 includes a ferrule 68 for terminating an optical fiber. The ferrule 68 includes a port 70 through which lights signals can exit and/or enter the signal-carrying structure 68. For instance, the ferrule 68 can include an optical fiber and a facet of the optical fiber can serve as the port 70. The port 70 is received in the secondary alignment device 60. As noted above, an exterior port 14 from the attenuating insert 11 is also received in the secondary alignment device 60. Accordingly, the secondary alignment device 60 aligns the port 70 with the exterior port 14 from the attenuating insert 11.

The alignment of the port and the exterior port 14 permits exchange of optical signals between the second optical fiber connector 72 and the attenuating insert 11. As noted above, the attenuating insert 11 can exchange optical signals with the first optical fiber connector 66. As a result, the first optical fiber connector 66 can exchange optical signals with the second optical fiber connector 72 through the attenuating insert 11. For instance, optical signals from the first optical fiber connector 66 can pass through the attenuating insert 11 and be received at the second optical fiber connector 72. In addition to optical signals traveling from the first optical fiber connector 66 to the second optical fiber connector 72 or as an alternative to the optical signals traveling from the first optical fiber connector 66 to the second optical fiber connector 72, optical signals from the second optical fiber connector 72 can pass through the attenuating insert 11 and be received at the first optical fiber connector 66. The optical signal passes through the attenuator 16 when traveling through the attenuating insert 11. Accordingly, the attenuator 16 may attenuate the power of the optical signals that exit from the attenuating insert 11 before the optical signals are received at the first optical fiber connector 66 or the second optical fiber connector 72.

Although the device 31 is shown above as having a female interface 48 and a male interface 44, the device 31 can be adapted to have two male interfaces or two female interfaces. For instance, the adapter 64 of FIG. 3A through FIG. 3C can be integrated into the device 31 of FIG. 2A through FIG. 2E to provide a device 31 with two female interfaces.

Although FIG. 3A through FIG. 3C illustrate the device 31 connected to optical fiber connectors 66, 72, one or both ends of the device 31 can be directly connected to another optical device, optical component and/or an opto-electronic circuit board.

FIG. 4A and FIG. 4B illustrate an example of a scattering filter 91 that can be used as the attenuator 16. FIG. 4A is a sideview of the scattering filter 91. FIG. 4B illustrates a portion of an attenuating insert 11 that includes a scattering filter 91 functioning as the attenuator 16. The optical signal labeled A is an input signal that is incident on the scattering filter. The optical signal labeled B is the output signal that is output by the scattering filter. The optical signals labeled S the portion of the input signal that is scattered by the scattering filter.

The scattering filter includes a scattering film 90 positioned on a substrate 92. The film 91 is positioned such that the optical signals traveling along the optical path of the device 31 travel through the film. The scattering film 90 can scatter an optical signal passing through the scattering film 90. The substrate 92 is configured to transmit the optical signal. Accordingly, a portion of the input signal is transmitted through the filter and becomes the output signal while another portion of the optical signal is scattered. The scattering film 90 includes nanoparticles 94 suspended in a support 96. The support 96 is preferably transparent or substantially transparent and has an index of refraction that is dependent on temperature. The nanoparticles 94 and the support 96 are selected such that different zones in the support 96 each have an index of refraction that changes in response to a nanoparticle adjacent to the zone absorbing a portion of the optical signal. The difference between the index of refraction in the zones and in the rest of the support 96 causes scattering of the optical signals as the optical signals travel through the film 90.

The nanoparticles 94 are selected to be particles that heat up in response to absorbing light. Accordingly, the temperature of the nanoparticles 94 elevates when the nanoparticles 94 absorb light. The elevated temperature is transferred into the support creating zones of elevated temperature in the support. Since the index of refraction of the support is dependent on temperature, the index of refraction is altered in these zones. The zones of altered index of refraction causes portions of an optical signal traveling through the scattering film 90 to be scattered rather than being transmitted through the film 90. The scattered portion of the optical signal is effectively attenuated.

The attenuation mechanism employed by the scattering film 90 of FIG. 4A can permit the attenuator 16 to produce an output signal with a substantially constant power for a range of input signal powers. For instance, FIG. 4C illustrates the performance of a suitable scattering filter having a scattering film constructed according to FIG. 4A. The x-axis is the power of the input signal measured in dBm and the y-axis is the power of the output signal measured in dBm. The curve illustrates the power of the output signal as a function of the input signal power. The curve includes a dynamic attenuation range extending from an input signal power of about 12 dBm to more than 17 dBm and particularly from 15 dBm to more than 17 dBm. For instance, the power of the output signal remains substantially constant over the input signal power range of 12 dBm to more than 17 dBm and particularly from 15 dBm to more than 17 dBm. In particular, the output signal power varies over less than 1 dBm while the input signal power is varied over at least 5 dBm or the output signal power varies over less than 0.1 dBm while the input signal power is varied over at least 2 dBm. Accordingly, the film can be employed as a passive dynamic attenuator. The dynamic attenuation range shown in FIG. 4C is believed to result from saturation of the film at increase input signal power levels.

The curve also shows an upper threshold in the power of the output signal at around 10 dBm. The power of the output signal does not exceed the upper threshold as the power of the input signal changes. Accordingly, the scattering film limits the power of the output signal. As a result, the scattering film can be employed as an optical limiter. For instance, when the input signal has a variable power and the one or more devices that receive the output signal can be harmed by high levels of output signal power, the scattering film can prevent damage to those devices by limiting the power of the output signal to a power that is below the power level where damage can occur.

Experimental results show that substantially raising the power of the input signal once the upper threshold is achieved can cause the scattering film to burn out and become opaque such that the scattering filter fails to produce a substantial output signal. As a result, the scattering film can be employed as an optical fuse. For instance, when the input signal has a variable power and the one or more devices that receive the output signal can be harmed by high levels of output signal power, the scattering film can prevent damage to those devices by terminating the output signal before the power of the output signal reaches a level where damage can occur.

In some instances, the film does not provide substantial attenuation at low input signal power levels. As a result, the attenuator need not provide attenuation at all levels of input signal power.

The performance characteristics of a film constructed according to FIG. 4A can be changed by changing the density of the nanoparticles in the support 96, by changing the thickness of the film, and/or by changing the type of nanoparticles in the scattering film.

The nanoparticles can have an average diameter that is less than 0.5 micron or less than 0.1 micron. The nanoparticles can include or consist of one or more one or more components selected from a group consisting of: Ag, Au, Ni, Va, Ti, Co, Cr, C, Re, and Si. In one example, the nanoparticles are carbon black particles. The support 96 can be polymers such as polymethylmethylacrylate (pmma), pmma derivatives, polymers based on epoxy resins. The support 96 can be other materials such as glass, spin-on-glass (SOG), or other sol-gel materials.

Additional details about scattering films and scattering film construction suitable for use within the attenuator 16 are found in U.S. patent application Ser. No. 10/398,859, filed on Apr. 7, 2004, entitled “Optical Power Limiter,” which is incorporated by reference herein in its entirety.

Although FIG. 4A and FIG. 4B illustrate the scattering film positioned on a substrate. The scattering film can be positioned between substrates. Alternately, the scatting film can serve as the scattering filter. For instance, the scattering filter can exclude substrates.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

We claim:

1. An optical device, comprising:
a housing having a front connector interface and a rear connector interface and housing an optical pathway from the front connector interface to the rear connector interface,
the front connector interface being configured to be coupled with a first optical connector such that an optical signal from the first optical connector travels along the optical pathway, and
the rear connector interface being configured to be coupled with a second optical connector such that the second optical connector receives the optical signal from the optical pathway; and
an attenuator in the housing configured to scatter a portion of the optical signal traveling along the optical pathway such that power of the optical signal is attenuated.

2. The optical device of claim 1, wherein a first signal-carrying structure and a second signal-carrying structure at least partially define the optical pathway,
the first signal-carrying structure includes a first port through which the optical signal enters and/or exits the first light-signal carrying structure, and
the second signal-carrying structure includes a second port through which the optical signal enters and/or exits the second light-signal carrying structure, and the attenuator is positioned between the first port and the second port.

3. The optical device of claim 2, wherein one or more urging mechanisms in the housing urge the first signal-carrying structure toward the second signal-carrying structure.

4. The optical device of claim 2, wherein the first port has a non-perpendicular angle relative to the direction of propagation of the optical signal through the first signal-carrying structure at the first port, and
the second port has a non-perpendicular angle relative to the direction of propagation of the optical signal through the second signal-carrying structure at the second port.

5. The optical device of claim 4, wherein the first port is angled physical contact (APC) polished and the second port is angled physical contact (APC) polished.

6. The optical device of claim 4, wherein a rotational orientation of the first signal-carrying structure relative to the housing is fixed, rotational orientation of the first signal carrying structure resulting from rotation of the first signal-carrying structure around the optical pathway, and
a rotational orientation of the second signal-carrying structure relative to the housing is fixed, rotational orientation of the second signal-carrying structure resulting from rotation of the second signal-carrying structure around the optical pathway.

7. The optical device of claim 6, wherein
a first retainer positioned on the first signal-carrying structure includes a first alignment structure that is complementary to a first alignment structures on the housing,
the first signal-carrying structure is received in the housing such that the first alignment structure is aligned with the first alignment structure on the housing,
a second retainer positioned on the second signal-carrying structure includes a second alignment structure that is complementary to a second alignment structures on the housing, and
the second signal-carrying structure is received in the housing such that the second alignment structure is aligned with the second alignment structure on the housing.

8. The optical device of claim 1, wherein the first signal-carrying structure includes a ferrule and the second signal-carrying structure include a ferrule.

9. The optical device of claim 1, wherein the housing is constructed of a front body coupled to a rear body, the front body including the front connector interface and the rear body including the rear connector interface.

10. The optical device of claim 1, wherein the attenuator includes a film having nanoparticles distributed in a support.

11. The optical device of claim 10, wherein the nanoparticles and the support are selected such that zones of the support each has an index of refraction that changes in response to one of the nanoparticles in contact with the zone absorbing a portion of the optical signal.

12. The optical device of claim 1, wherein the attenuator is configured to operate as an optical limiter by limiting the maximum power that can be reached by an output signal from the attenuator, the output signal being the portion of the optical signal that emerges from the attenuator after being attenuated and then traveling along the optical pathway.

13. The optical device of claim 1, wherein the attenuator is configured to operate as an optical fuse.

14. The optical device of claim 13, wherein the attenuator is configured such that the optical signal is transmitted through the attenuator and the attenuator is configured to become opaque to transmission of the optical signals when a power of the optical signals received by the attenuator exceeds a threshold.

15. The optical device of claim 1, wherein the housing is rigid.

16. An optical attenuator for use in an optical connector system, comprising:
a first ferrule having a terminal end for terminating a first optical fiber;
a second ferrule having a terminal end for terminating a second optical fiber;
a film for attenuating optical signals;
a sleeve configured to received therein the film and the first and second ferrules so that attenuating film is positioned between the terminal ends of the first and second ferrules and the first and second optical fibers are aligned along a predetermined optical path;
a first alignment structure protruding from the exterior of the first ferrule; and
a second alignment structure protruding from the exterior of the second ferrule.

17. The optical attenuator of claim 16, wherein the first and second alignment structures are configured to align the first and second ferrules in a predetermined rotational orientation relative to one another.

18. The optical attenuator of claim 17, wherein the first and second alignment structures are configured to cooperate with corresponding alignment structures formed in one or more optical device bodies for aligning the first and second ferrules in the predetermined rotational orientation relative to one another.

19. The optical attenuator of claim 16, wherein the first and second alignment structures are overmolded onto the first and second ferrules, respectively.

20. The optical attenuator of claim 16, wherein the terminal ends of the first and second ferrules are angled physical contact (APC) polished ends.
